(19) United States
(12) Patent Application Publication
(10) Pub. No.: US 2025/0286252 A1
(43) Pub. Date: Sep. 11, 2025

(54) SECONDARY BATTERY

(71) Applicant: Samsung SDI Co., Ltd., Yongin-si (KR)

(72) Inventors: Eun Ji KIM, Yongin-si (KR); Hyun Ki JUNG, Yongin-si (KR); Woo Hyuk CHOI, Yongin-si (KR); Myung Seob KIM, Yongin-si (KR); Gwan Hyeon YU, Yongin-si (KR); Yoon Sun YOO, Yongin-si (KR); Woo Tae JUN, Yongin-si (KR); Yoon Jong CHO, Yongin-si (KR); Gun Gue PARK, Yongin-si (KR); Sung Gwi KO, Yongin-si (KR)

(21) Appl. No.: 18/796,020

(22) Filed: Aug. 6, 2024

(30) Foreign Application Priority Data
Mar. 11, 2024 (KR) 10-2024-0033608

(51) Int. Cl. H01M 50/578; H01M 50/179; H01M 50/186; H01M 50/533; H01M 50/559; H01M 50/586; H01M 50/59

(52) U.S. Cl. CPC H01M 50/578; H01M 50/179; H01M 50/186; H01M 50/533; H01M 50/559; H01M 50/586; H01M 50/59; H01M 2200/20; H01M 2220/20

(57) ABSTRACT

Disclosed is a secondary battery capable of blocking supply of current when pressure in the secondary battery increases. The secondary battery includes a cylindrical can accommodating an electrode assembly, an integrated current collector located in the cylindrical can and electrically connected to the electrode assembly, a rivet unit disposed in contact with the integrated current collector to receive current and extending to the outside of the cylindrical can, and a terminal cover located outside the cylindrical can and configured to receive current through the rivet unit.

### CROSS-REFERENCE TO THE RELATED APPLICATION

The present application claims priority to and the benefit of Korean Patent Application No. 10-2024-0033608, filed on Mar. 11, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike a primary battery that cannot be recharged, a secondary battery is a battery that can be recharged and discharged. A low-capacity secondary battery may be used for portable small-sized electronic devices, such as smartphones, feature phones, notebook computers, digital cameras, and camcorders, and a high-capacity secondary battery may be used as a power source for driving a motor and a power storage battery in hybrid vehicles or electric vehicles. The secondary battery may include an electrode assembly having a positive electrode and a negative electrode, a case accommodating the electrode assembly, an electrode terminal connected to the electrode assembly, and the like.

The above-described information disclosed in the technology that serves as the background of the present disclosure is only for improving understanding of the background of the present disclosure and thus may include information that does not constitute the related art.

### SUMMARY

Embodiments provide a secondary battery configured to block a supply of current in response to pressure in the secondary battery increasing.

However, the technical problems to be solved by the present disclosure are not limited to the above-described technical problem, and other technical problems which are not mentioned will be clearly understood by those skilled in the art from the following description.

A secondary battery according to an embodiment includes a cylindrical can accommodating an electrode assembly, an integrated current collector in the cylindrical can and electrically connected to the electrode assembly, a rivet unit in contact with the integrated current collector to receive current and extending to the outside of the cylindrical can, and a terminal cover outside the cylindrical can and configured to receive current through the rivet unit.

In some examples, at least one of the integrated current collector or the rivet unit may rupture due to increase in pressure in the cylindrical can to block movement of current.

In some examples, the integrated current collector may include a current collecting body in contact with a positive electrode of the electrode assembly, a central body inside the current collecting body and electrically connected to the rivet unit, a bridge connecting the current collecting body to the central body, and a connection hole along the outer periphery of the central body together with the bridge.

In some examples, the central body may include a safety body at substantially the center of the current collecting body and mounted in contact with the rivet unit, a connection body mounted along the outer periphery of the safety body and connected to the safety body and the bridge, and a cut groove between the safety body and the connection body configured to rupture in response to an increase in pressure in the cylindrical can.

In some examples, the safety body may have a disc shape, and the bridge may include two or more bridges.

In some examples, the rivet unit may include an edge fixed to the cylindrical can and a central portion fixed in contact with the integrated current collector.

In some examples, the rivet unit may include a fixed body fixed to the cylindrical can to restricted in movement and a variable body extending from the fixed body in contact with the integrated current collector. In response to the integrated current collector rupturing due to the pressure of a gas, the variable body may be pushed by the integrated current collector and may rupture or be deformed.

In some examples, the variable body may include a first notch a first groove in a circumferential direction and a second notch inside the first notch and forming a second groove in the circumferential direction.

In some examples, in response to the pressure in the cylindrical can increasing, the first notch may induce rupture of the variable body, and the second notch may induce bending of the variable body.

In some examples, the depth of the first groove formed by the first notch may be greater than the depth of the second groove formed by the second notch.

In some examples, the secondary battery may further include a first insulating member located between the fixed body and the cylindrical can and include an insulative material.

In some examples, the rivet unit may further include an extension body extending from the fixed body to the outside of the cylindrical can and a bent body extending from the extension body and in contact with an outer side of the cylindrical can and electrically connected to the terminal cover.

In some examples, the secondary battery may further include a second insulating member between the integrated current collector and the fixed body and including an insulative material configured to block movement of current.

A secondary battery according to an embodiment includes a cylindrical can accommodating an electrode assembly, an integrated current collector in the cylindrical can and electrically connected to the electrode assembly, a rivet unit in contact with the integrated current collector to receive current and extending to the outside of the cylindrical can, a terminal cover outside the cylindrical can and configured to receive current through the rivet unit, and a spacer between the rivet unit and the terminal cover and including an inner space defined therein to allow the rivet unit to move thereinto.

In some examples, at least one of the integrated current collector or the rivet unit may be configured to rupture in response to an increase in pressure in the cylindrical can to block movement of current.

In some examples, the spacer may include a spacer body between the terminal cover and the rivet unit and including an insulative material and a sidewall member extending from the edge of the spacer body to support the rivet unit.

In some examples, the integrated current collector may include a current collecting body in contact with a positive electrode of the electrode assembly, a central body located inside the current collecting body and electrically connected to the rivet unit, a bridge connecting the current collecting body to the central body, and a connection hole along the outer periphery of the central body together with the bridge.

In some examples, the bridge may include two or more bridges and the connection hole may include two or more connection holes, and the number of bridges and the number of connection holes may be identical to each other.

In some examples, the central body may include a safety body located at the center of the current collecting body and mounted in contact with the rivet unit, a connection body mounted along the outer periphery of the safety body and connected to the safety body and the bridge, and a cut groove between the safety body and the connection body that is configured to rupture in response to an increase in pressure in the cylindrical can.

In some examples, the rivet unit may include a fixed body fixed to the cylindrical can so as to be restricted in movement and a variable body extending from the fixed body so as to be in contact with the integrated current collector. In response to the integrated current collector rupturing due to the pressure of a gas, the variable body may be pushed by the integrated current collector and may rupture or be deformed.

In some examples, in response to the pressure in the cylindrical can increasing, the cut groove may rupture, the safety body may be moved to the interior of the spacer, and the variable body in contact with the safety body may be moved to the interior of the spacer, whereby flow of current to the terminal cover may be blocked.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIGS. 1 and 2 are, respectively, a perspective view and a cross-sectional view showing a secondary battery according to an embodiment;

FIG. 3 is an exploded perspective view of the secondary battery according to the embodiment;

FIG. 4 is a cross-sectional view showing a state in which a rivet unit is in contact with an integrated current collector according to an embodiment;

FIG. 5 is a cross-sectional view showing a state in which flow of current is blocked due to deformation of the rivet unit and the integrated current collector by pressure according to the embodiment;

FIG. 6 is a perspective view showing a state in which flow of current is blocked due to deformation of the rivet unit and the integrated current collector by pressure according to the embodiment;

FIG. 7 is a plan view of an integrated current collector according to another embodiment;

FIGS. 8 to 11 are plan views of integrated current collectors according to still other embodiments;

FIGS. 12A and 12B are perspective views showing a battery pack including the secondary battery according to the embodiment; and

FIGS. 13A and 13B are, respectively, a perspective view and a side view showing vehicles including the battery pack according to the embodiment.

### DETAILED DESCRIPTION

Hereinafter, preferred embodiments of the present disclosure will be described in detail with reference to the accompanying drawings. Prior to this, the terms and words used in the present specification and claims should not be construed as being limited to their usual or dictionary meanings and should be interpreted as meanings and concepts consistent with the proposed technical spirit of the present disclosure based on the principle that the inventor may appropriately define the concept of terms to describe his/her invention in the best way. Accordingly, since the embodiments disclosed in the present specification and configurations shown in the drawings are only some of the most preferred embodiments of the present disclosure and do not represent the entire technical spirit of the present disclosure, it should be understood that there are various equivalents and modifications which may replace them at the time of filing the present application.

Further, when used in the present specification, “comprise or include” and/or “comprising or including” specify the presence of mentioned shapes, numbers, steps, operations, members, and/or groups thereof and do not exclude the presence or addition of one or more other shapes, numbers, steps, operations, members, and/or groups thereof.

Further, in order to help understanding of the invention, the accompanying drawings are not drawn to actual scale and the sizes of some components may be exaggerated. In addition, the same reference numerals may be given to the same components in different embodiments.

Stating that two objects for comparison are ‘the same’ means that that the two objects are ‘substantially the same.’ Accordingly, ‘substantially the same’ may include a deviation considered to be a low level in the art, for example, a deviation within 5%. Further, uniformity of a parameter in a certain area may mean uniformity from an average perspective.

Although first, second, and the like are used to describe various components, these components are not limited by these terms. These terms are only used to distinguish one component from another component, and a first component may also be a second component unless otherwise stated.

Throughout the specification, unless otherwise stated, each component may be singular or plural.

Disposition of an arbitrary component at “an upper portion (or a lower portion)” of a component or “on (or under)” the component means that the arbitrary component may be disposed in contact with an upper surface (or a lower surface) of the component or another component may be interposed between the component and the arbitrary component disposed on (or under) the component.

Further, when it is described that a certain component is “connected,” “coupled,” or “linked” to another component, it should be understood that the components may be directly connected or linked to each other, but still another component may be “interposed” between the components, or the components may be “connected,” “coupled,” or “linked” through still another component. In addition, a case in which a certain part is electrically connected to another part includes not only a case in which the parts are directly connected, but also a case in which the parts are connected with another element therebetween.

Throughout the specification, “A and/or B” refers to A, B, or A and B unless otherwise stated. That is, “and/or” includes all or any combination of a plurality of listed items. “C to D” means greater than or equal to C and less than or equal to D unless otherwise specified.

The terms used in the present specification are provided for describing the embodiments of the present disclosure, and are not intended to limit the present disclosure.

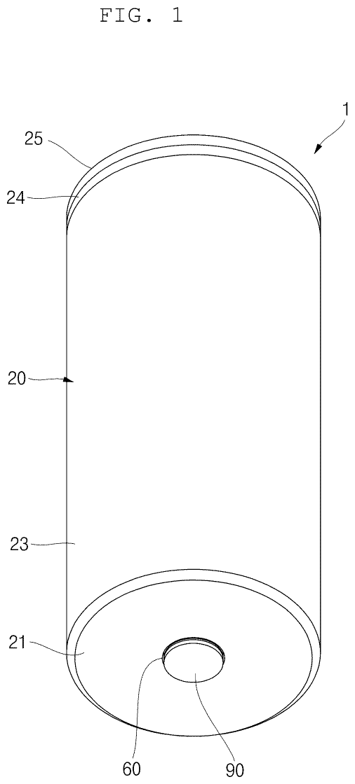

FIGS. 1 and 2 area perspective view and a cross-sectional view, respectively, showing a secondary battery 1 according to an embodiment. As shown in FIGS. 1 and 2, the secondary battery 1 according to the embodiment may include an electrode assembly 10, a cylindrical can 20, an integrated current collector 50, a rivet unit 70, and a terminal cover 90. In some embodiments, the secondary battery 1 may further include at least one of a cap plate 30, a negative electrode current collector 40, a first insulating member 60, a second insulating member 62, a third insulating member 64, and/or a spacer 80. As used herein, the secondary battery 1 may be referred to as a cylindrical secondary battery 1 or a battery.

The cylindrical can 20 may have any suitable configuration so long as the electrode assembly 10 is accommodated therein. The cylindrical can 20 may accommodate the electrode assembly 10 and an electrolyte, and may define the external appearance of the secondary battery 1 together with the cap plate 30. As used herein, the cylindrical can 20 may include or be referred to as a case, a can, a housing, or an exterior body. The cylindrical can 20 may have any suitable shape so long as the cylindrical can 20 accommodates the electrode assembly 10. The cylindrical can 20 includes a terminal hole 22 in one side thereof and an open inlet in the other side thereof. The cylindrical can 20 may include a circular base portion 21 and a side surface portion 23 extending from an edge of the base portion 21 in a vertical longitudinal direction. The base portion 21 and the side surface portion 23 of the cylindrical can 20 may be integral with each other. The circular base portion 21 may have a flat circular plate shape and may include a terminal hole 22 extending through the central portion thereof. A rivet unit 70 may be inserted into the terminal hole 22 to be coupled to the base portion 21.

A first insulating member 60 for sealing and electrical insulation may be additionally mounted between the terminal hole 22 and the rivet unit 70. The first insulating member 60 may block contact between the cylindrical can 20 and the rivet unit 70 and may electrically isolate the cylindrical can 20 and the rivet unit 70 from each other. The terminal hole 22 in the base portion 21 may be sealed by the first insulating member 60 and the rivet unit 70. The first insulating member 60 and second and third insulating members 62 and 64 to be described later may be made of resin such as polyethylene (PE), polypropylene (PP), or polyethylene terephthalate (PET).

During a process of manufacturing the secondary battery 1, the upper portion of the cylindrical can 20 (based on configuration of the battery in FIG. 2) may be open. Therefore, during a process of manufacturing the secondary battery 1, the electrode assembly 10 may be inserted into the cylindrical can 20 through the open upper portion of the cylindrical can 20 together with an electrolyte. That is, the electrolyte and the electrode assembly 10 may be inserted into the cylindrical can 20 in a direction from the open upper portion toward the lower portion. After the electrolyte and the electrode assembly 10 are inserted into the cylindrical can 20, the cap plate 30 may be coupled to the open upper portion of the cylindrical can 20 to seal the interior of the cylindrical can 20.

The electrolyte may be configured to allow lithium ions to move between a positive electrode plate and a negative electrode plate of the electrode assembly 10. The electrolyte may be a non-aqueous organic electrolyte that is a mixture of lithium salt and a high-purity organic solvent. In other embodiments, the electrolyte may be a polymer using a polymer electrolyte or may be a solid electrolyte. However, the type of electrolyte is not limited thereto.

The cylindrical can 20 may include steel, a steel alloy, aluminum, an aluminum alloy, or an equivalent thereto. However, the material of the cylindrical can 20 is not limited thereto. The cylindrical can 20 may include a beading portion 24 and a crimping portion 25 below and above the cap plate 30, respectively, in order to prevent (or at least mitigate) the electrode assembly 10 from being separated to the outside.

The beading portion 24 may be depressed toward the inside of the cylindrical can 20 and may surround a lower edge of the cap plate 30. The crimping portion 25, which is connected to the beading portion 24, may be bent toward the inside of the cylindrical can 20 and surround an upper edge of the cap plate 30.

Because the beading portion 24 is formed after the electrode assembly 10 is inserted into the cylindrical can 20 through the open upper end portion of the cylindrical can 20, it may be possible to prevent the electrode assembly 10 from being separated from the cylindrical can 20.

In an embodiment in which both the beading portion 24 and the crimping portion 25 are included in the cylindrical can 20, the crimping portion 25 may be located above the beading portion 24. The crimping portion 25 may press the edge of the cap plate 30, thereby firmly fixing the cap plate 30.

The electrode assembly 10 may be accommodated in the case together with the electrolyte. The electrode assembly 10 may include or be referred to as an electrode group, an electrode body, or a jellyroll. The electrode assembly 10 may include a first electrode plate 11, a second electrode plate 12, and a separator 13 between the first electrode plate 11 and the second electrode plate 12. The electrode assembly 10 may be wound in a cylindrical shape. In some embodiments, a hollow core may be provided at the center of the electrode assembly 10 in the vertical longitudinal direction (vertical direction in FIG. 2).

The first electrode plate 11 may include a first substrate and a first active material layer located on the first substrate. The first substrate may include a first uncoated portion or a first tab on which the first active material layer is not located. The first uncoated portion or the first tab of the first substrate may extend outward (e.g., downward), and the first tab may be electrically connected to the positive electrode current collector. In one or more embodiments, the first electrode plate 11 may be a positive electrode plate or a positive electrode.

The second electrode plate 12 may include a second substrate and a second active material layer located on the second substrate. The second substrate may include a second uncoated portion or a second tab on which the second active material layer is not located. The second uncoated portion or the second tab of the second substrate may extend outward (e.g., upward), and the second tab may be electrically connected to the negative electrode current collector 40. In some embodiments, the first tab and the second tab may extend in opposite directions. In one or more embodiments, the second electrode plate 12 may be a negative electrode plate or a negative electrode.

The first electrode plate 11 may function as a positive electrode. In an embodiment in which the first electrode plate 11 is a positive electrode, the first substrate may be, for example, an aluminum foil, and the first active material layer may include, for example, a transition metal oxide. The second electrode plate 12 may function as a negative electrode. In an embodiment in which the second electrode plate 12 is a negative electrode, the second substrate may be, for example, a copper foil or a nickel foil, and the second active material layer may include, for example, graphite and/or silicone.

The separator 13 may be configured to prevent a short circuit between the first electrode plate 11 and the second electrode plate 12 and allow lithium ions to move therebetween. In some embodiments, the separator 13 may be located on each of two opposite side surfaces of the first electrode plate 11 or may be located on each of two opposite side surfaces of the second electrode plate 12.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O₂₋ₐDa (0.90≤a≤1.8, 0≤b≤0.5, 0≤c≤50.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO2, TiO2, SnO2, Ce02, MgO, NiO, CaO, GaO, ZnO, ZrO2, Y₂O₃, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The cap plate 30 may be a circular metal plate and may be coupled to the upper end portion of the cylindrical can 20. The cap plate 30 may be fixed to the cylindrical can 20 by forming the crimping portion 25 at the upper end of the cylindrical can 20 in a configuration in which the edge of the cap plate 30 is seated on the beading portion 24 of the cylindrical can 20. The cap plate 30 may be seated on the beading portion 24 in a configuration in which the open inlet of the cylindrical can 20 faces upward.

The cap plate 30 may be fixed and electrically connected to the negative electrode current collector 40 and the cylindrical can 20 through welding. The cap plate 30 may have the same polarity as the negative electrode current collector 40. In one or more embodiments, the cap plate 30 may have a circular plate shape.

In one or more embodiments, an insulating member may be provided between the cap plate 30 and the cylindrical can 20. If the insulating member is provided, the cap plate 30 and the cylindrical can 20 may not be electrically connected to each other and thus may not have the same polarity. In an embodiment in which the insulating member is provided, the cap plate 30 may be electrically neutral, and the cylindrical can 20 may be electrically negative.

The cap plate 30 may include a cap notch 32, which forms a groove portion, that is configured to be opened at a predetermined pressure. In response to the pressure in the cylindrical can 20 reaching a rupture pressure or higher, the cap notch 32 of the cap plate 30 may be configured to rupture, thereby preventing the secondary battery 1 from exploding.

The negative electrode current collector 40 may be any suitable shape such that the negative electrode current collector 40 is accommodated in the cylindrical can 20 and electrically interconnects the cylindrical can 20 and the second electrode plate 12 (the negative electrode plate).

The negative electrode current collector 40 according to the embodiment may include a body portion 42 in contact with the second electrode plate 12 (the negative electrode plate) and a connection tab 44 extending outward from the body portion 42 and fixed to the cylindrical can 20. In some embodiments, the negative electrode current collector 40 may further include a notch groove configured to rupture in response to an increase in the pressure in the cylindrical can 20.

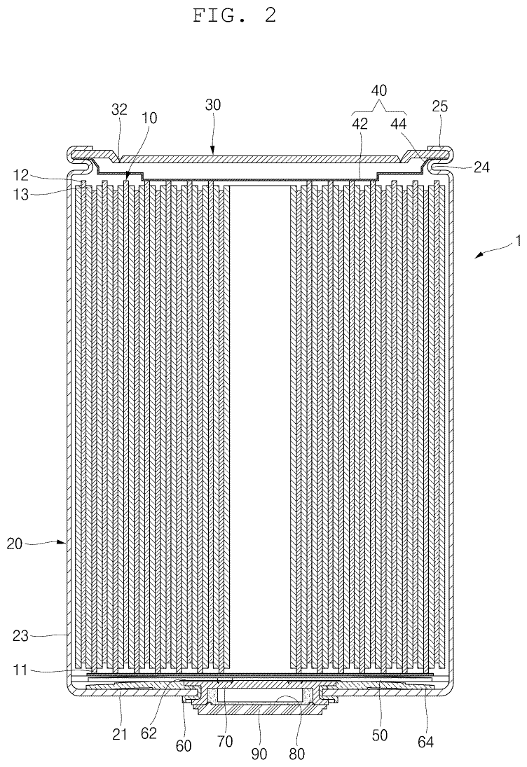

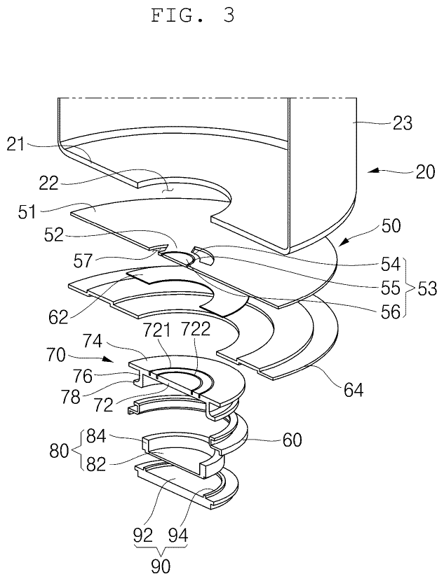

FIG. 3 is an exploded perspective view of the secondary battery 1 according to the embodiment, and FIG. 4 is a cross-sectional view showing a configuration in which the rivet unit 70 is in contact with the integrated current collector 50 according to the embodiment. As shown in FIGS. 3 and 4, the integrated current collector 50 may be located in the cylindrical can and may be electrically connected to the electrode assembly 10 (see FIG. 2). The integrated current collector 50 may be configured to function as a positive electrode current collector that is fixed to the electrode assembly 10 and receives a current. The integrated current collector 50 may also be configured to function as a cap-down that forms a flow path through which a fluid moves toward the rivet unit 70. The integrated current collector 50 according to the embodiment may include a current collecting body 51, at least one bridge 52, a central body 53, and at least one connection hole 57.

The current collecting body 51 may have any suitable configuration such that the current collecting body 51 is electrically connected to the electrode assembly 10 and is located in the cylindrical can 20. The current collecting body 51 may be located between the base portion 21 and the electrode assembly 10 and may be electrically connected to the electrode assembly 10. The current collecting body 51 according to the embodiment may be fixed in contact with the first electrode plate 11 (the positive electrode) of the electrode assembly 10. The current collecting body 51 may have a shape corresponding to the shape of the lower surface of the electrode assembly 10, and may be, for example, a circular metal plate. The planar size of the current collecting body 51 may be substantially equal to or smaller than the size of the lower surface of the electrode assembly 10. The current collecting body 51 may include aluminum (Al). The upper surface of the current collecting body 51 may be fixed through welding in a state of being in contact with the lower portion of the electrode assembly 10. The current collecting body 51 may be fixed and electrically connected to the first electrode plate 11 (the positive electrode plate) exposed downward from the electrode assembly 10.

The current collecting body 51 may include a hole in substantially the center thereof, and the central body 53 may be located inside the current collecting body 51. The central body 53 and the current collecting body 51 may be spaced apart from each other. The bridge 52 may have any suitable configuration such that the bridge 52 interconnects the current collecting body 51 and the central body 53. The bridge 52 may interconnect the current collecting body 51 and a connection body 54 provided at the central body 53 such that the bridge 52 is configured to function as a passage for the movement of current.

The central body 53 may have any suitable configuration such that the central body 53 is located inside the current collecting body 51 and is electrically connected to the rivet unit 70. Because the lower surface of the central body 53 is fixed through welding in a state of being in contact with the upper surface of the rivet unit 70, the central body 53 may be fixed and electrically connected to the rivet unit 70. Because the central body 53 is electrically connected to the current collecting body 51 via the bridge 52 and the lower side of the central body 53 is electrically connected to a variable body 72 of the rivet unit 70 in contact therewith and welded thereto, the central body 53 is configured to function as a current flow path. The central body 53 according to the embodiment may include a connection body 54, a cut groove 55, and a safety body 56.

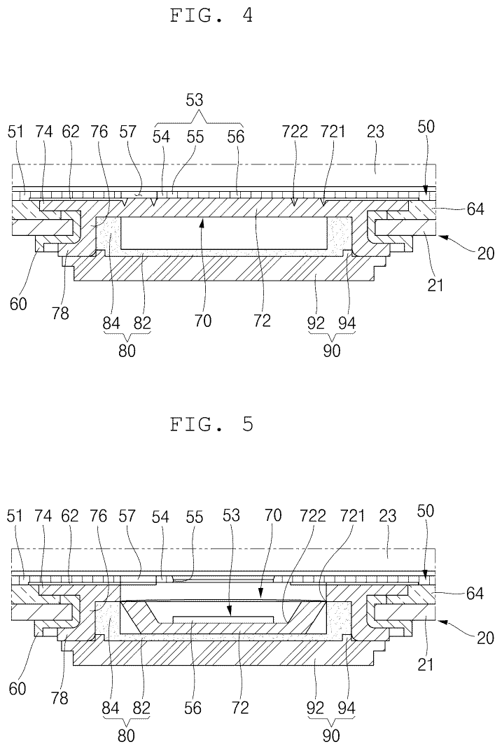

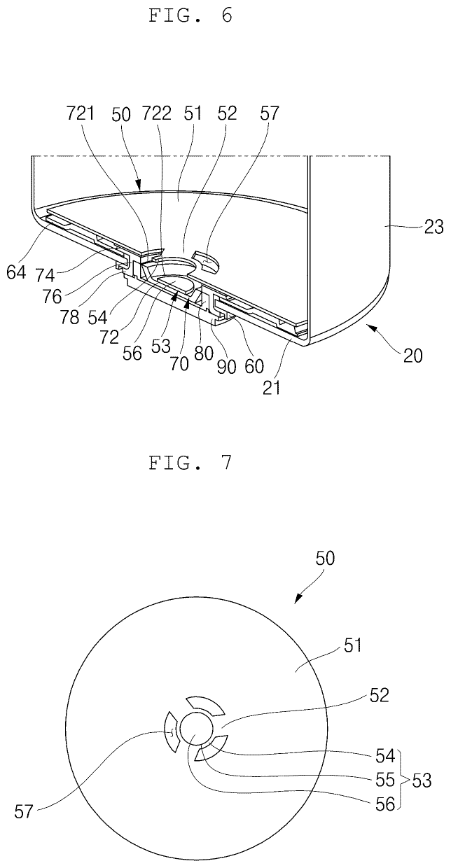

FIG. 5 is a cross-sectional view showing a state (or configuration) in which the flow of current is blocked due to deformation of the rivet unit 70 and the integrated current collector 50 in response to pressure according to the embodiment, and FIG. 6 is a perspective view showing a state (or configuration) in which the flow of current is blocked due to deformation of the rivet unit 70 and the integrated current collector 50 in response to pressure according to the embodiment. As shown in FIGS. 5 and 6, the central body 53 may have any suitable configuration in which the central body 53 is located at substantially the center of the current collecting body 51 and is in contact with the rivet unit 70. The integrated current collector 50 including the safety body 56 may be a conductor. The safety body 56 according to the embodiment may be a disc and may be located at substantially the center of the current collecting body 51.

The connection body 54 may have any suitable configuration such that connection body 54 is mounted along the outer periphery of the safety body 56 and is connected to the safety body 56 and the bridge 52. In an embodiment in which the safety body 56 is a disc, the connection body 54 may be mounted in a ring shape (e.g., an annulus) along the outer periphery of the safety body 56. The safety body 56 and the connection body 54 may be integral with each other. The connection body 54 may be connected to the bridge 52. The safety body 56 according to the embodiment may have a disc shape, and the bridge 52 may include a plurality of bridges 52.

The cut groove 55 may have any suitable configuration in which the cut groove 55 is between the safety body 56 and the connection body 54 and is configured to rupture in response to an increase in the pressure in the cylindrical can 20. The thickness of the safety body 56 and the thickness of the connection body 54 may be substantially identical to each other, and the thickness of the cut groove 55 may be less than the thickness of the safety body 56. In response to the pressure increasing, the cut groove 55 having a ring shape may rupture, and thus, the safety body 56 may fall down from the integrated current collector 50 and may move into the spacer 80. In one or more embodiments in which the cut groove 55 ruptures in response to the increase in the pressure in the cylindrical can 20, the safety body 56 may move into the spacer 80, and the variable body 72, which is in contact with the safety body 56, may also move into the spacer 80, whereby flow of current to the terminal cover 90 may be blocked.

The connection hole 57 may have any suitable configuration in which the connection hole 57 is along the outer periphery of the central body 53 together with the bridge 52. The bridge 52 may include a plurality of bridges 52 and the connection hole 57 may include a plurality of connection holes 57, and the number of bridges 52 and the number of connection holes 57 may be identical to each other. The shapes of the bridge 52 and the connection hole 57 may be variously modified.

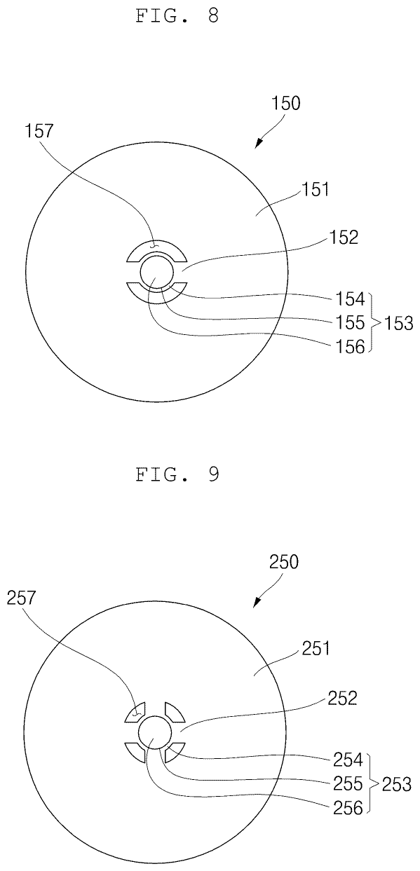

FIG. 7 is a plan view of an integrated current collector 50 according to another embodiment. As shown in FIG. 7, the integrated current collector 50 according to the other embodiment may include a current collecting body 51, at least one bridge 52, a central body 53, and at least one connection hole 57. The central body 53 may include a connection body 54, a cut groove 55, and a safety body 56. Because this embodiment is different from the above-described embodiment only in the number of bridges 52 and the number of connection holes 57, only the bridges 52 and the connection holes 57 will be described. In an embodiment in which the number of bridges 52 is three, the number of connection holes 57 between the bridges 52 may also be three.

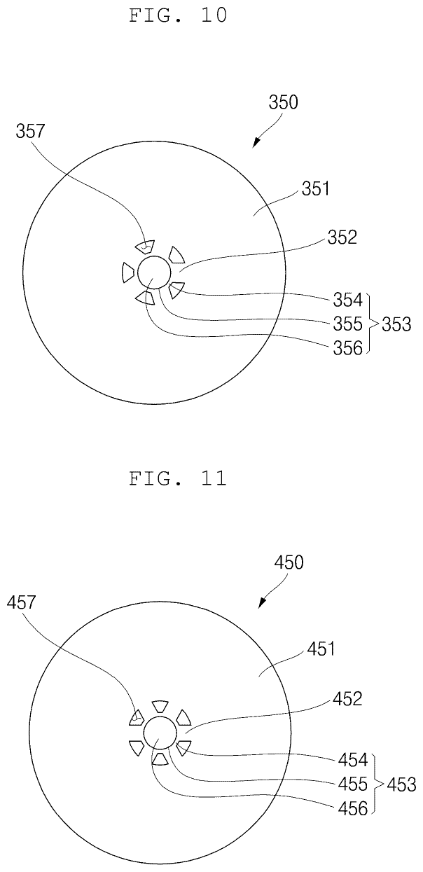

As shown in FIG. 8, an integrated current collector 150 according to still another embodiment may include a current collecting body 151, at least one bridge 152, a central body 153, and at least one connection hole 157. The central body 153 may include a connection body 154, a cut groove 155, and a safety body 156. Because this embodiment is different from the above-described embodiments only in the number of bridges 152 and the number of connection holes 157, only the bridges 152 and the connection holes 157 will be described. In an embodiment in which the number of bridges 152 is two, the number of connection holes 157 between the bridges 152 may also be two.

As shown in FIG. 9, an integrated current collector 250 according to still another embodiment may include a current collecting body 251, at least one bridge 252, a central body 253, and at least one connection hole 257. The central body 253 may include a connection body 254, a cut groove 255, and a safety body 256. Because this embodiment is different from the above-described embodiments only in the number of bridges 252 and the number of connection holes 257, only the bridges 252 and the connection holes 257 will be described. In an embodiment in which the number of bridges 252 is four, the number of connection holes 257 between the bridges 252 may also be four.

As shown in FIG. 10, an integrated current collector 350 according to still another embodiment may include a current collecting body 351, at least one bridge 352, a central body 353, and at least one connection hole 357. The central body 353 may include a connection body 354, a cut groove 355, and a safety body 356. Because this embodiment is different from the above-described embodiments only in the numbers of bridge 352 and the number of connection holes 357, only the bridges 352 and the connection holes 357 will be described. In an embodiment in which the number of bridges 352 is five, the number of connection holes 357 between the bridges 352 may also be five.

As shown in FIG. 11, an integrated current collector 450 according to still another embodiment may include a current collecting body 451, at least one bridge 452, a central body 453, and at least one connection hole 457. The central body 453 may include a connection body 454, a cut groove 455, and a safety body 456. Because this embodiment is different from the above-described embodiments only in the number of bridges 452 and the number of connection holes 457, only the bridges 452 and the connection holes 457 will be described. In an embodiment in which the number of bridges 452 is six, the number of connection holes 457 between the bridges 452 may also be six.

As shown in FIGS. 3 and 4, the first insulating member 60 may be located between a fixed body 74 of the rivet unit 70 and the cylindrical can 20 and may include an insulative material. The first insulating member 60 may have any suitable configuration in which the first insulating member 60 is mounted between the rivet unit 70 and the cylindrical can 20 and includes an insulative material. The first insulating member 60 according to the embodiment may be mounted between the rivet unit 70 and the base portion 21 including the terminal hole 22 formed therein. Thus, the first insulating member 60 may be configured to block the movement of current flowing along the rivet unit 70 to the base portion 21 of the cylindrical can 20. The first insulating member 60 may be configured to function as a gasket for sealing and electrical insulation. The first insulating member 60 may include a resin such as polyethylene (PE), polypropylene (PP), or polyethylene terephthalate (PET).

The second insulating member 62 may have any suitable configuration in which the second insulating member 62 is mounted between the integrated current collector 50 and the fixed body 74 of the rivet unit 70 and includes an insulative material configured to block the movement of current. The second insulating member 62 according to the embodiment may be formed in a ring shape (e.g., an annulus). The second insulating member 62 may be mounted between the current collecting body 51 of the integrated current collector 50 and the fixed body 74 of the rivet unit 70. Thus, the second insulating member 62 may be configured to block the movement of current from the current collecting body 51 to the fixed body 74.

The third insulating member 64 may have any suitable configuration in which the third insulating member 64 is mounted between the integrated current collector 50 and the base portion 21 and includes an insulative material configured to block the movement of current. The third insulating member 64 according to the embodiment may be mounted along the periphery of the rivet unit 70 and may have a plate shape. Because the third insulating member 64 is mounted between the current collecting body 51 of the integrated current collector 50 and the base portion 21, the third insulating member 64 may be configured to block the movement of current from the current collecting body 51 to the base portion 21.

The rivet unit 70 may have any suitable configuration in which the rivet unit 70 is in contact with the integrated current collector 50 and is configured to receive a current and extends to the outside of the cylindrical can 20. At least one of the integrated current collector 50 or the rivet unit 70 may be configured to rupture in response to an increase in the pressure in the cylindrical can 20 and to thereby block movement of current. In the secondary battery 1 according to the embodiment, the boundaries around the safety body 56 of the integrated current collector 50 and the variable body 72 of the rivet unit 70 may be configured to rupture in response to an increase in the pressure in the cylindrical can 20 and to thereby block the movement of current. The edge of the rivet unit 70 may be fixed to the cylindrical can 20, and the central portion of the rivet unit 70 may be fixed in contact with the integrated current collector 50. The rivet unit 70 according to the embodiment may include a variable body 72, a fixed body 74, an extension body 76, and a bent body 78.

The variable body 72 may have any suitable configuration in which the variable body 72 extends from the fixed body 74 and is in contact with the integrated current collector 50 and is configured to rupture or deform by being pushed by the integrated current collector 50 rupturing in response to the pressure of the gas inside the battery 1. The variable body 72 may be fixed to the integrated current collector 50 through welding.

A plurality of groove-shaped notches may be in the variable body 72 in order to induce deformation of the variable body 72. The variable body 72 according to the embodiment may include a first notch 721 forming a first groove extending in a circumferential direction (e.g., a circle) and a second notch 722 located inside the first notch 721 and forming a second groove extending in the circumferential direction (e.g., a circle). In response to the pressure in the cylindrical can 20 increasing, the first notch 721 may be configured to induce rupture of the variable body 72, and the second notch 722 may be configured to induce bending of the variable body 72. In some embodiments, the depth of the first groove formed by the first notch 721 may be greater than the depth of the second groove formed by the second notch 722.

In response to the pressure in the cylindrical can 20 becoming substantially equal to or higher than a rupture pressure, the variable body 72 may be moved by rupture or bending of the first notch 721 and the second notch 722, thereby blocking movement of current and thus preventing the secondary battery 1 from exploding. Because the first notch 721 and the second notch 722 are bent or rupture in response to the generation of excessive internal pressure in the cylindrical can 20, it may be possible to discharge excessive internal pressure from the cylindrical can 20 and to block flow of current from the integrated current collector 50 to the terminal cover 90.

The first notch 721 and the second notch 722 of the variable body 72 may be spaced apart from the center of the variable body 72 and may each have a ring shape when viewed in plan. In other embodiments, the first notch 721 and the second notch 722 may have multiple patterns. The embodiments are not limited to any specific shapes of the first notch 721 and the second notch 722.

The fixed body 74 may be located in the cylindrical can 20 and may be restricted in movement. The fixed body 74 may be mounted along the outer periphery of the variable body 72, and the fixed body 74 and the variable body 72 may be connected to each other. The first notch 721 may be in the boundary between the fixed body 74 and the variable body 72. The second notch 722 may extend along the outer periphery of a portion of the variable body 72 that is welded to the integrated current collector. The fixed body 74 according to the embodiment may include the extension body 76 and the bent body 78.

The extension body 76 may have any suitable configuration such that the extension body 76 extends from the fixed body 74 to the outside of the cylindrical can 20. The extension body 76 may penetrate the terminal hole 22 in the base portion 21. The extension body 76 may have a cylindrical shape.

The bent body 78 may have any suitable configuration in which the bent body 78 extends from the extension body 76, engages the outer side of the cylindrical can 20 and is electrically connected to the terminal cover 90. The rivet unit 70 may have any suitable configuration in which the rivet unit 70 is a conductor and transmits current received through the integrated current collector to the terminal cover 90.

The spacer 80 may have any suitable configuration in which the spacer 80 is between the rivet unit 70 and the terminal cover 90 and includes an inner space defined therein to allow the rivet unit 70 to move thereinto. The spacer 80 may include an insulative material. In some embodiments, the spacer 80 may include a spacer body 82 located between the terminal cover 90 and the rivet unit 70 and include an insulative material and a sidewall member 84 extending from the edge of the spacer body 82 to support the rivet unit 70.

The spacer body 82 may have a disc shape. The spacer body 82 may be mounted so as to face a terminal body 92 of the terminal cover 90. The spacer body 82 may be in contact with the terminal body 92.

The sidewall member 84 may be a cylindrical protrusion extending from the edge of the spacer body 82 toward the rivet unit 70. The height of the sidewall member 84 may be based on the moving distance of the variable body 72 of the rivet unit 70.

The terminal cover 90 may have any suitable configuration in which the terminal cover 90 is located outside the cylindrical can 20 and receives current through the rivet unit 70. The terminal cover 90 may be a conductor. The terminal cover 90 according to the embodiment may include a terminal body 92 and a terminal protrusion 94.

The terminal body 92 may have any suitable configuration in which the terminal body 92 is in contact with and electrically connected to the rivet unit 70. The terminal body 92 may be located outside the cylindrical can 20. The outer side of the terminal body 92 that is welded to a bus bar may have a flat surface, and thus, a welding area with the bus bar may be easily secured. The terminal body 92 may be formed in any of various shapes including a flat circular surface.

The terminal protrusion 94 may have any suitable configuration in which the terminal protrusion 94 is a protrusion protruding from the terminal body 92 toward the spacer 80. The terminal protrusion 94 according to the embodiment may protrude in a ring shape (annulus) and may be engaged with the lower side of the spacer 80 in order to restrict movement of the spacer 80.

As described above, in the secondary battery 1 according to the embodiment, a space may be defined between the terminal cover 90 and the rivet unit 70 in a configuration in which the integrated current collector 50 and the rivet unit 70 are in contact with each other. In response to the pressure in the cylindrical can 20 increasing, the cut groove 55 in the integrated current collector 50 may rupture, and thus, the safety body 56 may fall or otherwise move into the spacer 80. Also, the first notch 721 may rupture in response to the increase in pressure, and thus the variable body 72 of the rivet unit 70 may fall or otherwise move into the spacer 80 together with the safety body 56, whereby flow of current may be blocked.

The spacer 80 may be additionally mounted in order to define a space at a position at which the central portion of the rivet unit 70 is swollen. Because the spacer 80 is insulative, it may be possible to prevent (or at least mitigate) the swollen rivet unit 70 from coming into contact with or being electrically connected to the terminal cover 90.

As shown in FIG. 4, in response to the pressure in the cylindrical can 20 being normal, the variable body 72 of the rivet unit 70 may be in contact with the central body 53 of the integrated current collector 50 through welding. Thus, the current of the electrode assembly 10 may be transmitted to the central body 53 of the integrated current collector 50 through the current collecting body 51 and the bridge 52. The current transmitted to the central body 53 may be sequentially moved to the variable body 72, the extension body 76, and the bent body 78 of the rivet unit 70, and then may be moved to the terminal cover 90 that is in contact with the rivet unit 70.

As shown in FIGS. 5 and 6, in response to the pressure in the cylindrical can 20 increasing, the cut groove 55 in the integrated current collector 50 may rupture, and thus the safety body 56 and the connection body 54 may be separated from each other. The safety body 56 may press the variable body 72, connected to the lower side thereof, downward. The first notch 721 of the variable body 72 may rupture, and the variable body 72 may also fall down together with the safety body 56. The variable body 72 may be separated from the fixed body 74. Thus, transmission of current from the current collecting body 51 to the safety body 56 may be primarily blocked, and transmission of current from the variable body 72 to the fixed body 74 may be secondarily blocked.

In the secondary battery 1 according to the embodiment, in response to the pressure in the secondary battery 1 increasing, the integrated current collector 50 and the rivet unit 70 may be deformed to block the supply of current, thereby reducing the risk of fire. In the secondary battery 1 according to the embodiment, because two conventional parts are integrated into one integrated current collector 50, the number of parts may be reduced, and production cost may be reduced.

The battery according to the above-described embodiment may be used to manufacture a battery pack.

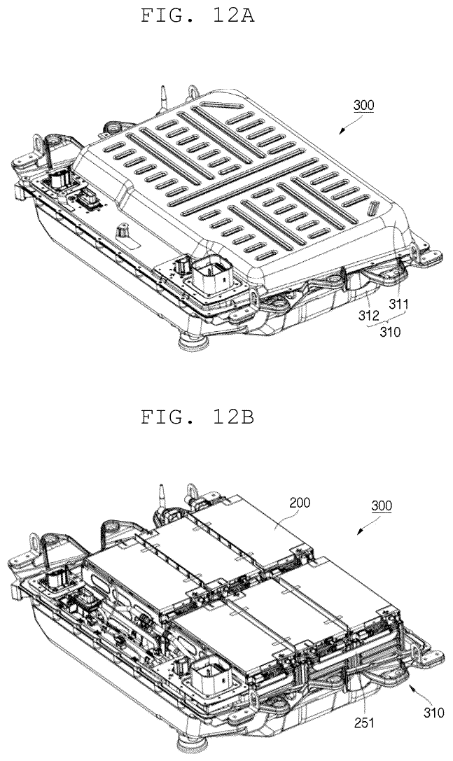

FIGS. 12a and 12b are perspective views showing a battery pack including the secondary battery 1 according to the embodiment.

Referring to FIGS. 12a and 12b, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

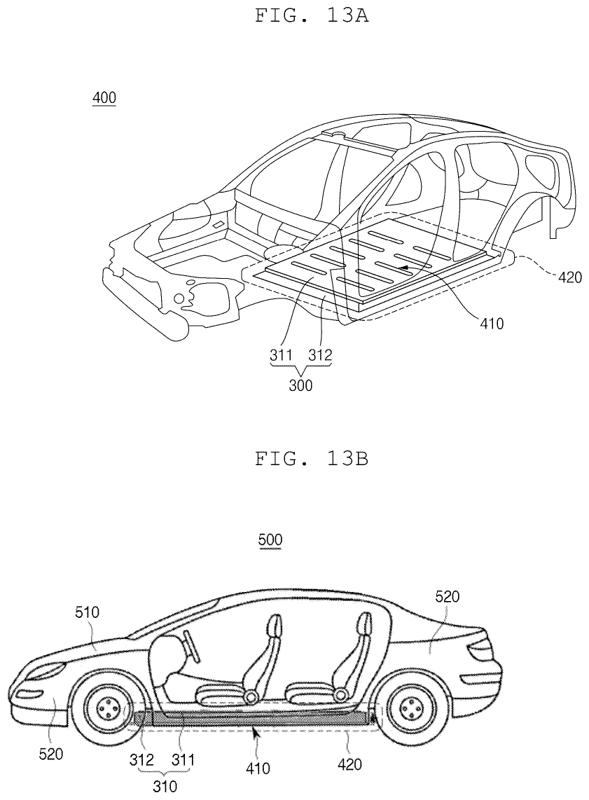

FIGS. 13a and 13b are, respectively, a perspective view and a side view showing vehicles 400 and 500 including the battery pack 300 according to the embodiment.

In FIG. 13a, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13b, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, according to the embodiment, in response to a pressure in a secondary battery increasing, an integrated current collector and a rivet unit may be deformed to block supply of current, thereby reducing the risk of fire.

According to the embodiment, because two conventional parts are integrated into one integrated current collector, the number of parts may be reduced, and production cost may be reduced.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and spirit of the disclosure, the scope of which is defined in the appended claims and their equivalents.

What is claimed is:

1. A secondary battery comprising:
a cylindrical can accommodating an electrode assembly;
an integrated current collector in the cylindrical can and electrically connected to the electrode assembly;
a rivet unit in contact with the integrated current collector and extending to an outside of the cylindrical can, the rivet unit being configured to receive current; and
a terminal cover outside the cylindrical can, the terminal cover being configured to receive the current through the rivet unit,
wherein at least one of the integrated current collector or the rivet unit is configured to rupture in response to an increase in pressure in the cylindrical can to block movement of the current.

2. The secondary battery as claimed in claim 1, wherein the integrated current collector comprises:
a current collecting body in contact with a positive electrode of the electrode assembly;
a central body inside the current collecting body and electrically connected to the rivet unit;
a bridge connecting the current collecting body to the central body; and
a connection hole along an outer periphery of the central body together with the bridge.

3. The secondary battery as claimed in claim 2, wherein the central body comprises:
a safety body at a center of the current collecting body and in contact with the rivet unit;
a connection body along an outer periphery of the safety body and connected to the safety body and the bridge; and
a cut groove between the safety body and the connection body, the cut groove being configured to rupture in response to an increase in pressure in the cylindrical can.

4. The secondary battery as claimed in claim 3, wherein the safety body has a disc shape, and wherein the bridge comprises a plurality of bridges.

5. The secondary battery as claimed in claim 1, wherein the rivet unit comprises an edge fixed to the cylindrical can and a central portion fixed in contact with the integrated current collector.

6. The secondary battery as claimed in claim 1, wherein the rivet unit comprises:
a fixed body fixed to the cylindrical can; and
a variable body extending from the fixed body and in contact with the integrated current collector, and
wherein, in response to the integrated current collector rupturing due to pressure of a gas, the variable body is pushed by the integrated current collector and ruptures or is deformed.

7. The secondary battery as claimed in claim 6, wherein the variable body comprises:
a first notch forming a groove in a circumferential direction; and
a second notch inside the first notch and forming a groove in the circumferential direction.

8. The secondary battery as claimed in claim 7, wherein, in response to pressure in the cylindrical can increasing, the first notch induces rupture of the variable body, and the second notch induces bending of the variable body.

9. The secondary battery as claimed in claim 8, wherein a depth of the groove formed by the first notch is greater than a depth of the groove formed by the second notch.

10. The secondary battery as claimed in claim 6, further comprising a first insulating member between the fixed body and the cylindrical can, the first insulating member comprising an insulative material.

11. The secondary battery as claimed in claim 6, wherein the rivet unit further comprises:
an extension body extending from the fixed body to an outside of the cylindrical can; and
a bent body extending from the extension body, the bent body contacting an outer side of the cylindrical can and electrically connected to the terminal cover.

12. The secondary battery as claimed in claim 6, further comprising a second insulating member between the integrated current collector and the fixed body, the second insulating member comprising an insulative material configured to block movement of current.

13. A secondary battery comprising:
a cylindrical can accommodating an electrode assembly;
an integrated current collector in the cylindrical can and electrically connected to the electrode assembly;
a rivet unit in contact with the integrated current collector and extending to an outside of the cylindrical can, the rivet unit being configured to receive current;
a terminal cover outside the cylindrical can, the terminal cover being configured to receive the current through the rivet unit; and
a spacer between the rivet unit and the terminal cover, the spacer comprising an inner space configured to allow the rivet unit to move thereinto,
wherein at least one of the integrated current collector or the rivet unit is configured to rupture in response to an increase in pressure in the cylindrical can to block movement of the current.

14. The secondary battery as claimed in claim 13, wherein the spacer comprises:
a spacer body located the terminal cover and the rivet unit, the spacer body comprising an insulative material; and
a sidewall member extending from an edge of the spacer body to support the rivet unit.

15. The secondary battery as claimed in claim 13, wherein the integrated current collector comprises:
a current collecting body in contact with a positive electrode of the electrode assembly;
a central body inside the current collecting body and electrically connected to the rivet unit;
a bridge connecting the current collecting body to the central body; and
a connection hole along an outer periphery of the central body together with the bridge.

16. The secondary battery as claimed in claim 15, wherein the bridge comprises a plurality of bridges and the connection hole comprising a plurality of connection holes, and
wherein a number of the plurality of bridges and a number of the plurality of connection holes are identical to each other.

17. The secondary battery as claimed in claim 15, wherein the central body comprises:
a safety body at substantially a center of the current collecting body and in contact with the rivet unit;
a connection body along an outer periphery of the safety body and connected to the safety body and the bridge; and
a cut groove between the safety body and the connection body, the cut groove being configured to rupture in response to an increase in pressure in the cylindrical can.

18. The secondary battery as claimed in claim 17, wherein the rivet unit comprises:
a fixed body fixed to the cylindrical can; and
a variable body extending from the fixed body and in contact with the integrated current collector, and
wherein, in response to the integrated current collector rupturing due to a pressure of a gas, the variable body is pushed by the integrated current collector and ruptures or is deformed.

19. The secondary battery as claimed in claim 18, wherein, in response to pressure in the cylindrical can increasing, the cut groove is configured to rupture, the safety body is configured to move to an interior of the spacer, and the variable body in contact with the safety body is configured to move to the interior of the spacer, whereby flow of current to the terminal cover is blocked.
